(19) United States
(12) Patent Application Publication
(10) Pub. No.: US 2015/0170227 A1
(43) Pub. Date: Jun. 18, 2015

(54) ASSESSING RATINGS USING TIP PATTERNS

(71) Applicant: Google Inc., (US)

(72) Inventors: Sheridan Virginia KATES, New York, NY (US); Amir Menachem Mané, Lincroft, NJ (US); Jeremy Brand Sussman, Bedford Hills, NY (US); Aaron Baeten Brown, Croton-on-Hudson, NY (US); Travis Harrison Kroll Green, Washington, DC (US); Arnaud Sahuguet, New York, NY (US)

(73) Assignee: Google Inc., Mountain View, CA (US)

(21) Appl. No.: 13/745,697

(22) Filed: Jan. 18, 2013

(51) Int. Cl. G06Q 30/02

(52) U.S. Cl. CPC G06Q 30/0282

(57) ABSTRACT

A computer-implemented method for assessing ratings using tip patterns is provided. The method includes obtaining tip information comprising a ratio of a tip amount associated with a bill for a service, the bill being associated with a service provider, generating a rating score based on the tip information and reference tip information, and generating an aggregate score associated with the service provider, based on the rating score. Systems and machine-readable media are also provided.

### TECHNICAL FIELD

The present disclosure generally relates to assessing ratings of service providers, and more particularly to using tip patterns to assess ratings of service providers.

### BACKGROUND

People use search engines to search for, and obtain information on, goods or service providers such as, for example, consumer products, restaurants, and tourist attractions. The information on the goods or service providers that people search for may include reviews or ratings.

### SUMMARY

According to an aspect of the present disclosure, a computer-implemented method for using tip patterns to assess ratings is provided. The method includes obtaining tip information from a bill for a service provided by a service provider, generating a rating score for the service provider based on the tip information and reference tip information, and generating an aggregate rating score for the service provider based at least in part on the rating score.

According to another embodiment of the present disclosure, a system for using tip patterns to assess ratings is provided. The system includes one or more memories storing executable instructions and one or more processors. The one or more processors are configured to execute the stored executable instructions to obtain tip information from a bill presented to a customer for a service provided by a service provider, generate a reference tip information based at least on historical tip information for the customer, generate a rating score for the service provider based on the tip information and the generated reference tip information, and generate an aggregate rating score for the service provider based at least in part on the rating score.

According to a further embodiment of the disclosure, a machine-readable storage medium including machine-readable instructions for causing a processor to execute a method for using tip patterns to assess ratings is provided. The method includes obtaining tip information comprising information of a service provider and a ratio of a tip amount associated with a bill presented to a customer for a service provided by the service provider, and generating a reference tip information based at least on historical tip information associated with the customer. The method also includes generating a rating score for the service provider based on the tip information and the generated reference tip information, including generating a higher rating score when the tip information is higher than the value of the reference tip information, and generating a lower rating score when the tip information is lower than the value of the reference tip information. The method further includes generating an aggregate rating score for the service provider based at least in part on the rating score.

### BRIEF DESCRIPTION OF THE DRAWINGS

A detailed description will be made with references to the accompanying drawings:

FIG. 1 illustrates an example architecture for using tip patterns to assess ratings.

FIG. 2 is a block diagram illustrating an example system for using tip patterns to assess ratings.

FIG. 3 is a conceptual diagram illustrating example processes for using tip patterns to assess ratings.

FIG. 4 illustrates a flow diagram of example operations for using tip patterns to assess ratings.

FIG. 5 is a conceptual diagram illustrating an example electronic system with which some implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Search engines may base their results, at least in part, on subjective information about places. For example, existing search engines may aggregate users' opinions into value numbers and generate search results based on these numbers. These opinions may take the form of user-submitted ratings and reviews such as star-scales and short textual write-ups. Aggregation of user check-ins may also be used. These methods require that the users actively submit this information or perform check-in operations. However, a majority of users do not perform these actions, and therefore the voice of these users may not be properly reflected in the search results.

According to the various aspects of the subject technology, a system and method for assessing ratings using tip patterns is provided. The system may receive information regarding the users' patterns on tip payments and generate scores or ratings for service providers such as, for example, restaurants. For example, the system may assign scores to the restaurants based on the amount (e.g., monetary amount or a percentage of total bill) of a tip left by a customer as compared to a reference value. The reference value may be determined for each customer and may be determined based on a variety of types of information. For example, the reference value may be determined based on the customer's past tips left at a specific restaurant, at similar types of restaurants, and/or restaurants in general. The reference value may also be determined based on tipping behaviors of other customers.

The scores may be provided in the form of valence scores where the scores indicate either a positive valence or a negative valence. For example, any tip percentage higher than reference value is given a +1, and any percentage lower than the reference value is given a −1. The scores may also be selected from a range of possible scores. For example, scores may be based on a scale of 1 to 10, with 5 being assigned to a reference value. The system may assign higher or lower scores to a restaurant based on the notion that an amount of tip paid by a customer generally reflects how favorable the customer's experience at the restaurant has been. The system may also consider the customer's tipping trend over time, and also the restaurant's tip received over time.

The phrases “check-in” or “checking in” as used herein encompass their plain and ordinary meaning, including, but not limited to, the act of indicating one's presence at or near a location. The location may be a predetermined location or an arbitrary location. A check-in may be performed, for example, using a social network.

The phrase “social network” as used herein encompasses its plain and ordinary meaning, including, but not limited to, an online service, platform or site that focuses on the building and reflecting of social associations and interactions among users. These associations may be stored within a social graph at each social networking service. Users of social networking services may create associations with one another (e.g., mutually identify as friends). Such user associations may be defined on a user-to-user basis, or as a group of users associated through membership within a group.

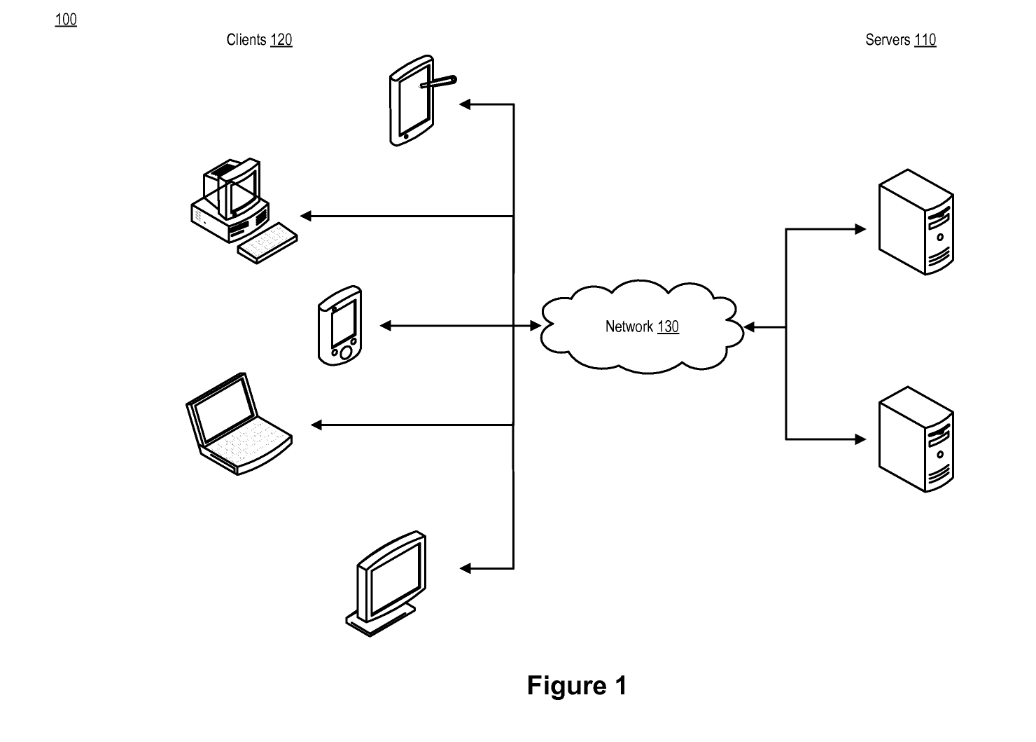

Turning to the drawings, FIG. 1 illustrates an example architecture 100 for assessing ratings using tip patterns. The architecture 100 includes servers 110 and clients 120 connected over a network 130. Each of the clients 120 may communicate with the servers 110 to assess ratings using tip patterns. The servers 110 may be any device having a processor, memory, and communications capabilities for communicating with the clients 120 to assess ratings using tip patterns. The clients 120 may be, for example, desktop computers, laptop computers, mobile devices (e.g., a smart phone, tablet computer, or PDA), set top boxes (e.g., for a television), televisions, video game consoles, home appliances (e.g., a refrigerator, microwave oven, washer, or dryer) or any other devices having a processor, memory, and communications capabilities for communicating with the servers 110 to assess ratings using tip patterns. The network 130 may include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

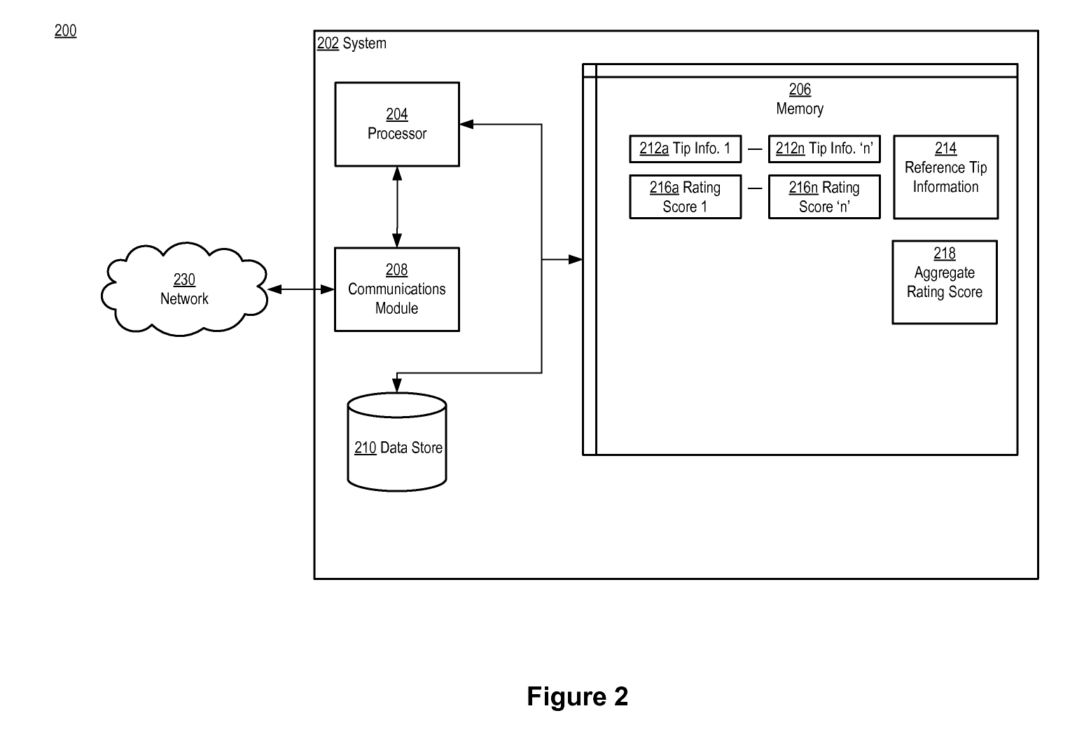

FIG. 2 is a block diagram 200 illustrating an example system 202 for assessing ratings using tip patterns. The system 202 may be implemented, for example, in one of the servers 110, across multiple servers, in one of the clients 120, across multiple clients, or across the servers and the clients. The system 202 is in communication with the network 230 (e.g., network 130) via a communications module 208. The communications module 208 is configured to interface with the network 230 to send and receive information, such as data, requests, responses, and commands to the other devices or systems on the network. The communications module 208 may be, for example, modems, Ethernet cards or mobile broadband adaptors.

The system 202 includes a processor 204, the communications module 208 and a memory 206 that includes tip information 212a-212n and reference tip information 214. Each tip information 212a-212n may include a monetary amount of a tip and a bill associated with a service provider, or a ratio of the tip to the bill. The service providers may be providers of any types of services for which tips are customarily given, such as, for example, services at restaurants, taxis, beauty salons, barbers, and valet services. The reference tip information 214 includes a reference value for the tip information 212a-212n. The reference value may be, for example, an average of all tip information 212a-212n, or an average of tip information associated with a single person. Other types of values may also be used for the reference tip information 214. The memory 206 also includes rating scores 216a-216n and an aggregate rating score 218. Each rating score 216a-216n includes a score generated based on each of the tip information 212a-212n and the reference tip information 214. The aggregate rating score 218 is generated by aggregating the rating scores 216a-216n that are associated with the same service provider.

The system 202 may also include a data store 210. The data store 210 may be integrated with the memory 206, or may be independent from the memory 206 and be in communication with the processor 204 and the memory 206. In an aspect of the subject technology, the tip information 212a-212n, the reference tip information 214, rating scores 216a-216n and aggregate rating score 218 may be stored in the data store 210 or may be spread across the data store and the memory 206.

The processor 204 is configured to execute instructions, such as instructions physically coded into the processor, instructions received from memory 206 in the form of software, or a combination of both. For example, the processor 204 is configured to execute instructions to obtain a piece of tip information (e.g., tip information 212a-212n) including a ratio of tip amount associated with a bill to an amount of the bill, where the bill is associated with a service provider. The processor is also configured to generate a rating score (e.g., rating scores 216a-216n) based on the piece of tip information and reference tip information (e.g., reference tip information 214). The bill may be associated with a customer and the reference tip information may be generated based on historical tip information associated with the customer. The processor is further configured to generate an aggregate score (e.g., aggregate score 218) associated with the service provider, based on the rating score.

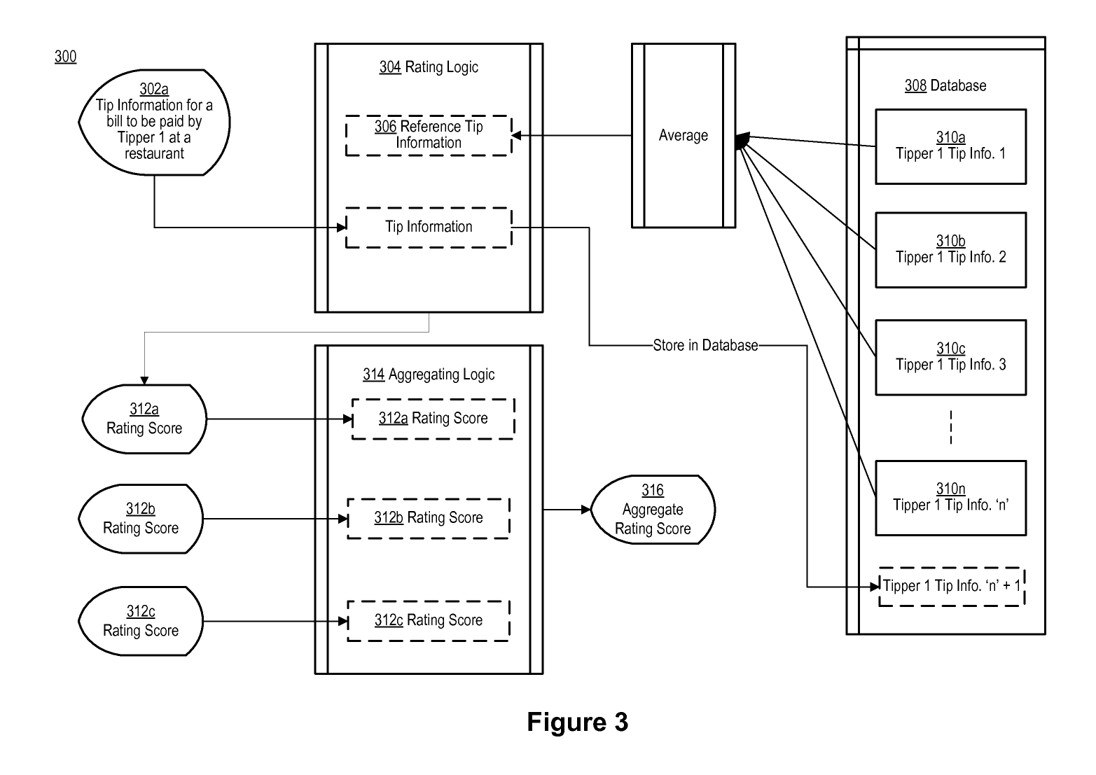

FIG. 3 is a conceptual diagram 300 illustrating example operations for assessing ratings using tip information. The operations may be performed, for example, by the system 202. A piece of tip information 302a (e.g., tip information 212a-212n) may be received, provided that authorization from the customer associated with the tip information is obtained. The customer may also revoke the authorization, after which tip information associated with the customer is no longer received. The tip information 302a may be a monetary amount of a tip paid by a customer to a service provider for services received, and the amount of bill associated with the tip. The tip information 302a may also be a ratio of a tip paid by a customer to an amount of bill associated with the tip. For example, if the bill is $100 and the tip paid for the bill is $20, then the ratio would be 20%. In the latter case, the amount of tip and the bill is not included in the tip information 302a.

In addition to the amount of tip and bill and/or the tip-to-bill ratio, the tip information 302a may also include information on the service provider associated with the tip information. Such information may be, for example, the restaurant's name, location, type of food served, price range, dress code, and operating hours.

The tip information 302a may be received from various sources. Such methods may include receiving information from financial institutions, such as, for example, credit card companies which process payments made using credit cards. The method may also include obtaining tipping and billing information from scanned or physical receipts. The customers and/or service providers may be given incentives to voluntarily scan in the receipts and provide the tipping and billing information. The tip information 302a may also be received from an intermediate system which securely receives the bill and tip amounts directly from the customers or service providers, and generates only the ratios between the two. In the case of service providers, they may provide tip and billing information only upon authorization from customers associated with the tip and billing information.

After the tip information 302a is received, a rating logic 304 is executed to generate a rating score 312a (e.g., rating scores 216a-216n) based on the received tip information and a reference tip information 306 (e.g., reference tip information 214). The rating logic 304 may be, for example, part of the instructions a processor, such as the processor 204, may execute. The rating logic 304 may be executed to compare the tip information 302a and the reference tip information 306 to generate a valence score. The valence score indicates either a positive value or a negative value. For example, if the tip information 302a is greater than the reference tip information 306, a positive valence score is generated. If the tip information 302a is less than the reference tip information 306, a negative valence score is generated. The positive valence score may be any positive value, and the negative valence score may be any negative value. As a specific example, for any tip information 302a having a value greater than the reference tip information 306, a rating score of +1 is generated. For any tip information 302a having a value less than the reference tip information 306, a rating score of −1 is generated.

The rating score 312a may also be generated using other methods. For example, the rating score 312a may be selected from a range of possible values. Specifically, the rating score 312a may be based on a scale of 1 to 10, with scores approaching the value 5 as the tip information 302a approaches the reference tip information 306, and approaches 1 or 10 as the tip information becomes less than or greater than the reference tip information.

In generating the rating score 312a, other factors, such as, for example, a customer's tipping trend over time, and the service provider's tips received over time, may also be considered. Specifically, if a customer has been recently tipping more in general regardless of the service provider, the customer's recent tip would have less significance in generating a rating score 312a than a tip given before the customer had been generally tipping more. Tipping trends of other customers may also be considered in generating the rating score 312a. For example, if the general customers in the geographic area around the restaurant are known to tip low, then the rating score 312a may be adjusted to be higher than rating scores generated for restaurants in other areas for the same value of tip information. Other methods, schemes or logic may also be used for generating the rating score 312a.

The reference tip information 306 may be generated based on historical tip information of a customer for all service providers for which the customer has tipped and for which information is available. The historical tip information of the customer for generating reference tip information 306 may also be limited in scope, for example, previous tip information by a customer at a single restaurant, at a certain type of restaurant, within a certain geographic area, or within a certain time frame. The reference tip information 306 may also be generated based on historical tip information of a varying scope of different customers for which tipping information is available. For example, tip information of all customers may be considered in generating the reference tip information 306, or only those satisfying a certain demographics may be used.

Diagram 300 shows generating the reference tip information 306 based on historical tip information 310a-310n of a single customer. The historical tip information 310a-310n may be stored in a database 308 (e.g., data store 210), and the reference tip information 306 may be generated by averaging the historical tip information 310a-310n. Other methods such as, for example, taking the median or mode of the historical tip information 310a-310n, may also be used. The received tip information 302a may also be stored in the database 308 as a new historical tip information entry, and the reference tip information 306 may be updated based on the new entry to be used in generating subsequent rating scores.

Multiple rating scores may be similarly generated based on multiple pieces of tip information associated with the same service provider. Diagram 300 shows that rating scores 312b and 312c are also generated in addition to the rating score 312a. An aggregating logic 314 may be executed to aggregate the rating scores 312a-312c to generate an aggregate rating score 316 (e.g., aggregate rating score 218). The aggregate rating logic 314 may be executed, for example, by the processor 204. The aggregate rating score 316 may be generated, for example, by adding all the rating scores 312a-312c. Specifically, if the rating scores 312a-312c have valence scores of +1, +1 and −1, respectively, the aggregate rating score 316 may be the sum of the scores 312a-31c, which is +1. Other methods, such as, for example, averaging, may also be used for generating the aggregate rating score 316. Specifically, if the rating scores 312a-312c have values chosen out of a range of 1-10 and each of a value of 5, 9, and 10, respectively, the aggregate rating score 316 is the average of the three values, which is 8.

As more rating scores are generated for the same service provider, the aggregating logic 314 may be executed to keep aggregating the rating scores to the aggregate rating score 316. Different aggregate rating scores may also be generated for different service providers.

The tipping information described above, such as the tip information 302a or the historical tip information 310a-310n, may be utilized in providing targeted advertisements to different customers and may also be used by the service providers to provide personalized services to the customers. For example, a restaurant may be able to recognize a customer who is a big tipper as soon as he or she walks in, and provide a higher level of service to the customer. The presence of a customer at a restaurant may be determined when the customer voluntarily indicates his or her current location. For example, the customer may indicate that he or she is at or near a restaurant by “checking in” at the restaurant through a social networking service.

The tipping information in conjunction with information on the associated service provider may also be used to infer the customer's different tastes. For example, if a customer consistently leaves a higher tip at Italian restaurants, such information may indicate that the customer enjoys Italian cuisine and may be used to provide targeted advertisements to the customer, provided that the customer has provided authorization for his or her tipping information to be used for providing advertisements.

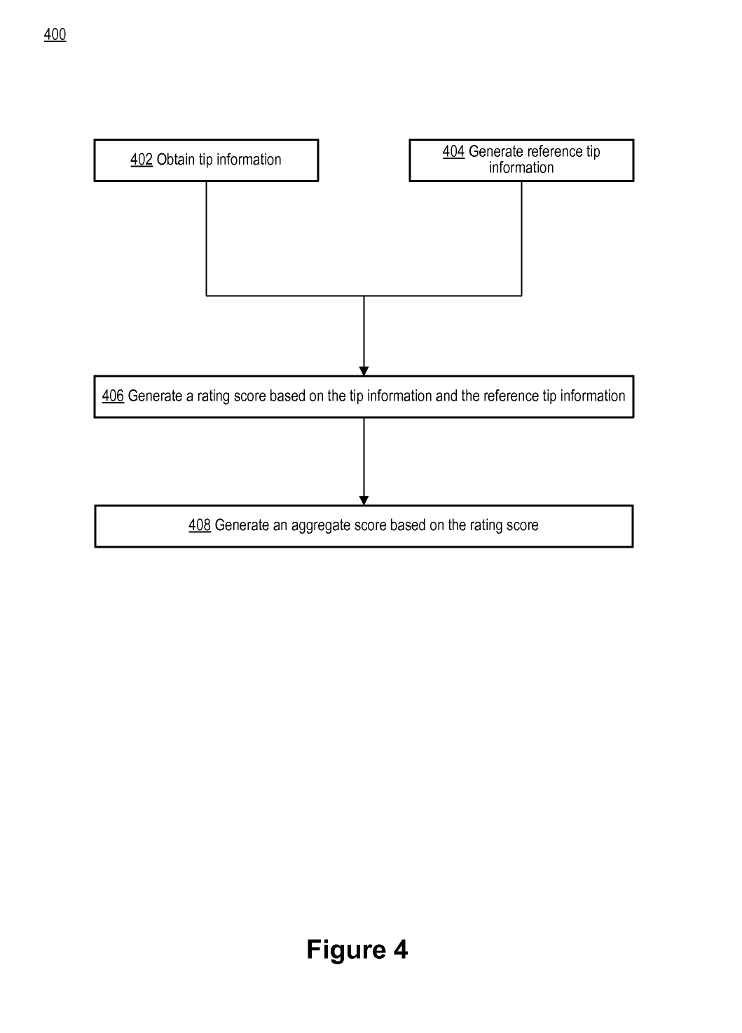

FIG. 4 illustrates a flow diagram 400 of example processes for assessing ratings using tip patterns. The processes may be performed, for example, by the system 202. In step 402, tip information (e.g., tip information 212a-212n) associated with a customer and a bill is received. The tip information may include a ratio of an amount of tip paid by the customer for the bill to a total amount of the bill. The bill may be associated with a service provider (e.g., a restaurant). In step 404, reference tip information (e.g., reference tip information 214) is generated based on historical tip information (e.g., historical tip information 310a-310n) for the customer. The historical tip information may encompass information on tips previously paid by the customer at the same restaurant. The historical tip information may also cover tips paid by the customer at similar types of restaurants (e.g., restaurants serving similar cuisine, restaurants at similar price ranges, restaurants within a certain geographic area), or restaurants in general. The historical tip information may also cover all tip information available for the customer.

Steps 402 and 404 may be performed simultaneously, or may be performed in sequence, regardless of the order. In step 406, a rating score is generated based on the tip information received in step 402 and the reference tip information generated in step 404. In step 408, an aggregate score (e.g., aggregate rating score 218) associated with the service provider associated with the tip information received in step 402 is generated. The aggregate score is generated based on the rating score.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, solid state disks or other computer-readable media, which can be read into memory for processing by a processor. Also, in some implementations, multiple software aspects of the subject technology can be implemented as sub-parts of a larger program while remaining distinct software aspects of the subject technology. In some implementations, multiple software aspects can also be implemented as separate programs. Finally, any combination of separate programs that together implement a software aspect described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

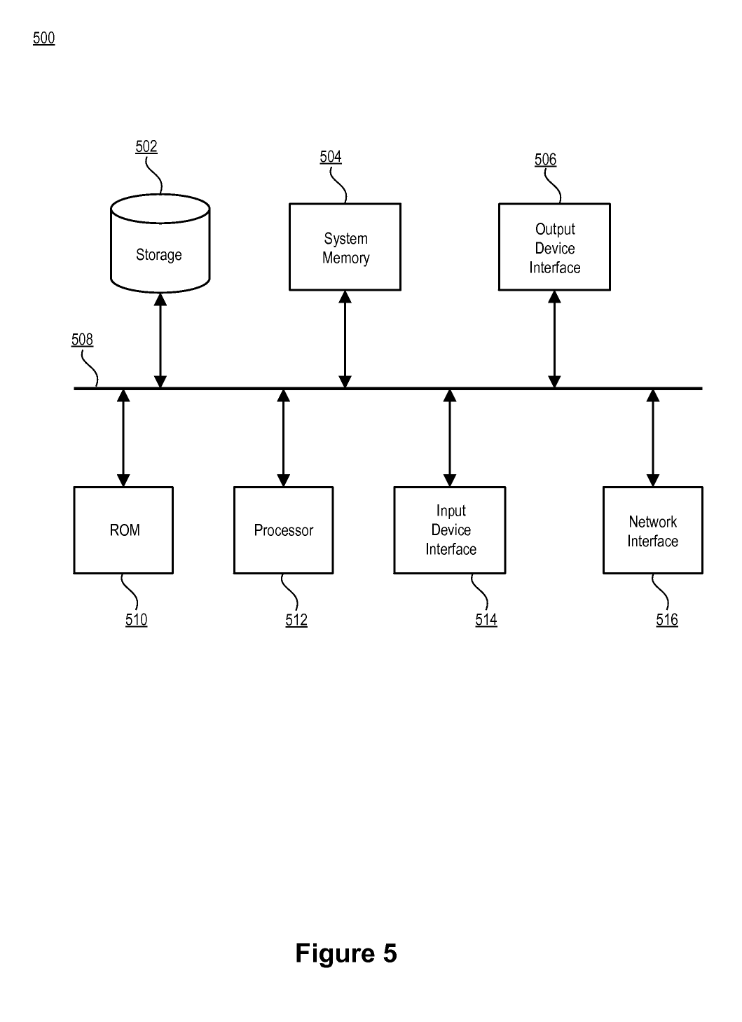

FIG. 5 conceptually illustrates an electronic system with which some implementations of the subject technology are implemented. Electronic system 500 can be a computer, phone, PDA, or any other sort of electronic device. Such an electronic system includes various types of computer-readable media and interfaces for various other types of computer-readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject technology. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject technology use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as random access memory. System memory 504 stores some of the instructions and data that the processor needs at runtime. In some implementations, the processes of the subject technology are stored in system memory 504, permanent storage device 502, and/or ROM 510. For example, the various memory units include instructions for assessing the sharing of items in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enable, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification of this application, the terms “computer”, “server”, “processor”, and “memory” all refer to electronic or other technological devices. These terms exclude people or groups of people. For the purposes of the specification, the terms display or displaying means displaying on an electronic device. As used in this specification of this application, the terms “computer-readable medium” and “computer-readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Aspects of the subject matter described in this specification can be implemented in a computing system that includes a backend component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such backend, middleware, or front end components. The components of the system can be interconnected by any form or medium of digital data communication, e.g., a communication network. Examples of communication networks include a local area network (“LAN”), a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that not all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein is used to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference.

What is claimed is:

1. A computer-implemented method for rating service providers based on customer tipping, the method comprising:
obtaining tip information from a bill for a service provided by a service provider;
generating a rating score for the service provider based on the tip information and reference tip information; and
generating an aggregate rating score for the service provider based at least in part on the rating score.

2. The method of claim 1, wherein the tip information comprises a ratio of a tip amount to a billed amount.

3. The method of claim 1, wherein the reference tip information is based at least on historical tip information of a customer presented with the bill.

4. The method of claim 3, further comprising generating a commercial message based on at least one of the tip information or the historical tip information associated with the customer, and communicating the commercial message to the customer.

5. The method of claim 3, wherein the historical tip information includes tip information for the service provider, tip information for other service providers in a vicinity of the service provider, or tip information for other service providers offering a same type of service as the service provider.

6. The method of claim 5, wherein the reference tip information is based at least on historical tip information of other customers, and includes tip information for the service provider, tip information for other service providers in a vicinity of the service provider, or tip information for other service providers offering a same type of service as the service provider.

7. The method of claim 1, wherein generating the rating score comprises:
generating a higher rating score when the tip information is higher than the value of the reference tip information; and
generating a lower rating score when the tip information is lower than the value of the reference tip information.

8. The method of claim 1, wherein obtaining the tip information comprises receiving the tip information from at least one of the service provider or a financial institution.

9. A system for assessing ratings using tip patterns, the system comprising:
one or more memories storing executable instructions; and
one or more processors configured to execute the stored executable instructions to:
obtain tip information from a bill presented to a customer for a service provided by a service provider;
generate a reference tip information based at least on historical tip information for the customer;
generate a rating score for the service provider based on the tip information and the generated reference tip information; and
generate an aggregate rating score for the service provider based at least in part on the rating score.

10. The system of claim 9, wherein the tip information comprises a ratio of a tip amount to a billed amount.

11. The system of claim 9, wherein the processor is further configured to:
generate a commercial message based on at least one of the tip information or the historical tip information associated with the customer; and
communicate the commercial message to the customer.

12. The system of claim 9, wherein the historical tip information includes tip information for the service provider, tip information for other service providers in a vicinity of the service provider, or tip information for other service providers offering a same type of service as the service provider.

13. The system of claim 12, wherein reference tip information is based at least on historical tip information of other customers, and includes tip information for the service provider, tip information for other service providers in a vicinity of the service provider, or tip information for other service providers offering a same type of service as the service provider.

14. The system of claim 9, wherein generating the rating score comprises:
generating a higher rating score when the tip information is higher than the value of the reference tip information; and
generating a lower rating score when the tip information is lower than the value of the reference tip information.

15. The system of claim 9, wherein the obtaining the tip information comprises receiving the tip information from at least one of the service provider or a financial institution.

16. A machine-readable storage medium comprising machine-readable instructions for causing a processor to execute a method for assessing ratings using tip patterns, the method comprising:
obtaining tip information comprising information of a service provider and a ratio of a tip amount associated with a bill presented to a customer for a service provided by the service provider;
generating a reference tip information based at least on historical tip information associated with the customer;
generating a rating score for the service provider based on the tip information and the generated reference tip information, comprising:
generating a higher rating score when the tip information is higher than the value of the reference tip information; and
generating a lower rating score when the tip information is lower than the value of the reference tip information; and
generating an aggregate rating score for the service provider based at least in part on the rating score.

17. The machine-readable storage medium of claim 16, wherein the method further comprises generating a commercial message based at least one of the tip information or the historical tip information associated with the customer, and communicating the commercial message to the customer.

18. The machine-readable storage medium of claim 16, wherein the historical tip information includes tip information for the service provider, tip information for other service providers in a vicinity of the service provider, or tip information for other service providers offering a same type of service as the service provider.

19. The machine-readable storage medium of claim 18, wherein the reference tip information is based at least on historical tip information of other customers, and includes tip information for the service provider, tip information for other service providers in a vicinity of the service provider, or tip information for other service providers offering a same type of service as the service provider.

20. The machine-readable storage medium of claim 16, wherein obtaining the tip information comprises receiving the tip information from at least one of the service provider or a financial institution.
